(19) United States
(12) Patent Application Publication
(10) Pub. No.: US 2006/0071849 A1
(43) Pub. Date: Apr. 6, 2006

(54) Tactical all weather precision guidance and navigation system

(75) Inventors: William M. Howle, Orlando, FL (US); Paul Y. Kim, Orlando, FL (US); George W. Knecht, Winter Park, FL (US); Stanloy L. Wheeler, Ocoee, FL (US); Chad Holden, Orlando, FL (US); Glonn J. Weinman, Orlando, FL (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Lockheed Martin Corporation, Bethesda, MD (US)

(21) Appl. No.: 10/953,274

(22) Filed: Sep. 30, 2004

(51) Int. Cl. G01S 5/14

(52) U.S. Cl. 342/357.08

(57) ABSTRACT

Precision navigation within a theater of operations is performed by receiving, at each of a plurality of spaced apart known locations, GPS satellite signals from a plurality of GPS satellites, wherein the known locations approximately define the theater of operations. A measure of error in the GPS satellite signal for each of the plurality of GPS satellites is determined. The measures of error in the GPS satellite signals are utilized to correct GPS satellite signals received at an unknown location within the theater of operations. The corrected GPS satellite signals are then used to determine a precise position of the unknown location within the theater of operations.

### GOVERNMENT LICENSE RIGHTS

The U.S. Government has a paid-up license in this invention and the right in limited circumstances to require the patent owner to license others on reasonable terms as provided for by the terms of “SDB CAD Program”, U.S. Government Contract No. F08635-C-0128.

### FIELD OF THE INVENTION

The present invention generally relates to navigation and guidance systems, and more particularly is directed to a closed loop precision navigation guidance system, which improves on information from navigational satellites, such as the Global Positioning System.

### BACKGROUND INFORMATION

The Global Positioning System (GPS) was implemented in the 1970's as a means to provide reliable positioning information for any location on the globe. Since its inception, the GPS has become increasingly employed in a variety of different types of applications that require accurate measurement of location on the surface of the earth. Some of the different applications which make use of information provided by the GPS include geo-location measuring applications, vehicle navigation applications, tracking applications, mapping applications and timing applications.

Data that is sent from GPS satellites can be used by location measuring applications to determine the position on the earth of a data-receiving device. GPS receivers may be useful for personal recreation activities, such as hiking, kayaking, skiing and other activities that may be carried out in remote locations. Location measuring applications may also be used in moving vehicles, such as automobiles and airplanes, to determine their instantaneous location, and thereby assist in navigating to a particular destination. Location measuring applications also find use in the military field, where increasingly more accurate position information is required for targeting and personnel location.

Navigation applications that employ GPS data are becoming more common in moving vehicles, particularly for determining the best path to be taken to reach a desired destination. For example, automobiles may incorporate GPS receivers to determine present location, and use this information in connection with known street layout information to determine the shortest, or most fuel efficient, path to a desired destination. Similarly, aircraft may employ GPS information for navigational purposes, as well as for landing and take-off guidance. In military applications, GPS data is useful in maneuvering blindly, such as at night, or without the aid of lights or other instruments.

Tracking applications employ GPS data to monitor the movement of people and things. For example, the military may employ GPS tracking applications to monitor the movement of troops and equipment. Emergency response systems might use tracking applications to determine the present location of emergency medical response teams, in an effort to minimize the time required to reach a victim at a desired location.

Mapping applications that utilize GPS signals can be used in cartography for creating more accurate maps. Land surveying and marine surveying may also be enhanced by mapping applications that utilize GPS information. In addition, construction and agriculture may both be improved by mapping applications that utilize precision GPS data to accurately align buildings or crops.

Other applications may employ GPS data to determine precise timing, for example to synchronize widely spaced devices. For example, applications such as mobile communications may achieve high levels of timing precision by utilizing the atomic clocks resident on GPS satellites, without incurring the high cost of incorporating such clocks themselves.

From the foregoing, it can be seen that many different applications make advantageous use of the data provided through the GPS. This data can be obtained from any one or more of the twenty-four satellites that currently constitute the GPS constellation. These satellites are placed in orbits such that a minimum of five satellites are in view from every point on the globe at any given time. Many GPS receivers are configured with an almanac, to enable the receiver to determine the present, or expected, location of each of the GPS satellites.

While the GPS data is useful in a variety of different applications, the preciseness of that data is subject to a number of different errors. For example, some of the errors which can affect the data at a GPS receiver include errors in the satellite clocks, satellite orbital ephemeris error, signal propagation delays induced by the ionosphere and troposphere, errors in the receiver clock, receiver noise, and multi-path propagation. The cumulative effect of these various errors can lead to differences of tens of meters between an actual position and the position indicated by the GPS receiver. These errors also vary with time since the GPS satellite constellation is moving relative to the Earth and the atmosphere is continually changing. While many applications are not sensitive to errors of this magnitude, such as automobile navigation or personnel tracking, other applications may require extremely precise positioning information. For example, in the landing of an airplane on an aircraft carrier, a positioning error of 10 meters could lead to very drastic results. Accordingly, various efforts have been undertaken to minimize the errors that are inherent to GPS data.

One commonly employed approach to reducing errors in GPS positioning data is known as “differential GPS.” In addition to the mobile GPS receiver that is employed to determine a location, differential GPS utilizes a second, stationary GPS receiver. The location of the stationary GPS receiver is precisely known, and therefore can be used to calculate errors in the signals from the GPS satellite. In essence, the stationary GPS receiver operates in the opposite manner from the mobile GPS receivers. Rather than employ signals from the GPS satellites to determine location, the stationary GPS receiver utilizes its known location to estimate what the signals from the various satellites should be. These estimated signals are then compared to the actual signals from the satellites, to compute the errors. These computed errors are used to calculate position-correction data, which is transmitted to the mobile receivers over line of sight (LOS) radio data links. At the mobile GPS receivers, the correction data is used to compensate for the errors in the received GPS satellite signals, and thereby provide a more precise determination of location.

While differential GPS enhances the accuracy of the Global Positioning System, its applicability is relatively limited. A significant consideration in this regard is the fact the mobile GPS receiver must be located relatively close to the stationary GPS receiver for the correction data to be useful. As the distance between the mobile GPS receiver and the stationary GPS receiver increases, the GPS satellite data errors which occur at their respective locations will differ, for example due to differing atmospheric and/or signal propagation conditions. Consequently, differential GPS systems are only effective in those situations where the mobile GPS receiver operates in an area that is within a few hundred miles of the stationary GPS receiver. At greater distances, the correction data from the stationary GPS receiver is no longer reliable.

This limited effective range of differential GPS restricts its applicability in certain situations. For example, differential GPS would not be available to ships or airplanes in the middle of the ocean. Similarly, in military applications it is not feasible to locate the stationary GPS receivers within a theater of combat. Hence, if the theater of operation is relatively large, differential GPS cannot be employed to locate or track equipment or personnel within its confines. To overcome these limitations in the ability to locate a target, terminal seekers are employed. These devices rely upon an operator to designate and track a target, for purposes of guiding a moving vehicle to the target. However, terminal seekers of this type are quite expensive, and therefore it is desirable to minimize their use. In addition, they cannot be employed in adverse weather, where the ability to designate the target is compromised. Current GPS technology cannot provide the precision position and velocity information required to reduce weapon system combined delivery errors to the levels achieved by terminal seekers today.

U.S. Pat. No. 5,899,957 to Loomis (henceforth, “Loomis”) discloses a method and apparatus for providing GPS pseudorange correction information over a selected geographic region S with a diameter of up to 300 km with an associated inaccuracy no greater than 5 cm. N spaced apart GPS reference stations (N>4), whose location coordinates are fixed and are known with high accuracy, are provided within or adjacent to a region R. Each reference station receives GPS signals from at least four common-view GPS satellites, computes its own GPS-determined location coordinates, compares these coordinates with its known location coordinates, determines the pseudorange corrections for its GPS-determined location, and transmits these correction signals to a central station located within or adjacent to a region S. The central station retransmits the pseudorange correction signals throughout the region S. A mobile GPS station within or adjacent to the region S has stored within it the coordinates of the GPS-determined last location of that mobile station and the spatial coordinates of K GPS reference stations (K>3) within S that are closest to the last-determined location of that mobile station. The mobile station then computes the differential GPS corrections for the GPS-determined present location of that mobile station.

The system of Loomis is limited in that the pseudorange correction signals retransmitted by the central station are useful only over a limited geographic area. It is therefore desired to provide a system capable of generating and supplying useful correction information to mobile GPS stations over a much greater area without the need for more reference receivers.

### SUMMARY OF THE INVENTION

The present invention provides a precise guidance and navigation system that is generally independent of weather conditions. Moreover, it is capable of generating useful correction information that can be supplied to mobile GPS receivers situated over a far greater geographic area than has been possible heretofore, while requiring fewer reference sensors than would have been required by prior art techniques covering the same geographic area.

In one embodiment, precision navigation within a theater of operations is performed by receiving, at each of a plurality of spaced apart known locations, GPS satellite signals from a plurality of GPS satellites, wherein the known locations approximately define the theater of operations. A measure of error in the GPS satellite signal for each of the plurality of GPS satellites is determined. The measures of error in the GPS satellite signals are utilized to correct GPS satellite signals received at an unknown location within the theater of operations. The corrected GPS satellite signals are then used to determine a precise position of the unknown location within the theater of operations.

An exemplary method for precision navigation within a theater of operations includes receiving via GPS receivers, at each of a plurality of spaced apart known locations, GPS satellite signals from a plurality of GPS satellites, wherein the known locations approximately define the theater of operations, providing the received GPS satellite signals to a central processing node, filtering the provided signals to differentiate between errors local to the known locations and errors specific to the GPS satellites, determining GPS satellite clock and ephemeris corrections based on the differentiated errors, and transmitting the determined GPS satellite clock and ephemeris corrections to mobile units within the theater of operations.

Further features of the invention, and the advantages provided thereby, are described in detail hereinafter with reference to exemplary embodiments of the invention illustrated in the accompanying drawings.

### BRIEF DESCRIPTION OF THE DRAWINGS

FIG. 1 is a schematic diagram of an all-weather precise guidance system in accordance with an exemplary embodiment of the present invention.

FIG. 2 is a general block diagram of the reference sensors, the central processing node (CPN), and the precision navigation unit (PNU).

FIG. 3 is a system architecture block diagram.

FIG. 4 is a flow diagram of the GPS Correction Algorithm.

FIG. 5 illustrates ionospheric delay estimation in an exemplary embodiment of the present invention.

FIG. 6 illustrates correction processes in a mobile rover or weapon, in accordance with exemplary embodiments of the present invention.

FIG. 7 illustrates an exemplary measurement update process.

FIG. 8 illustrates FIG. 8 shows an exemplary process whereby weather information is provided to a rover or PNU.

FIG. 9 illustrates an exemplary functional flow diagram of corrections and communications involving a precision navigation unit such as a rover or weapon.

FIG. 10 illustrates an exemplary system and method wherein correction data are indirectly supplied to one or more precision navigation units.

### DETAILED DESCRIPTION

To facilitate an understanding of the principles upon which the present invention is based, it is described hereinafter with reference to its application to military solutions in the guidance of a weapon towards a designated target. It will be appreciated, however, that the practical applications of the invention are not limited to this particular embodiment. Rather, the invention will find utility in a variety of different situations, which can benefit from precise location data. By way of example, the present invention can be further employed to provide precision guidance and navigation for a variety of mobile platforms such as planes, trains, ships, automobiles, as well as individuals.

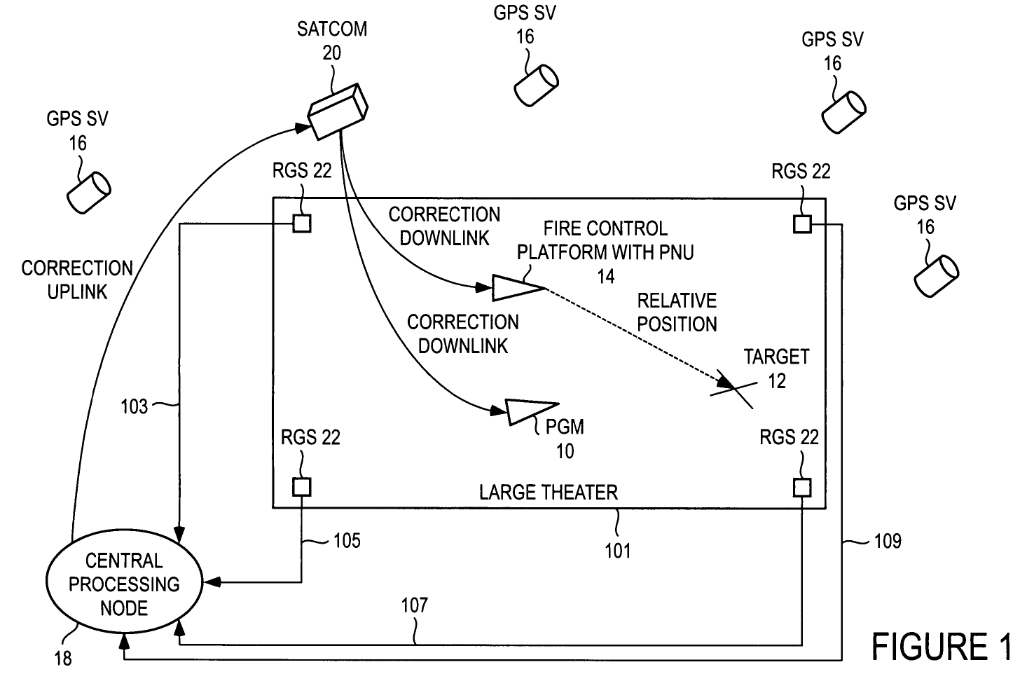

To further facilitate an understanding of the invention, an overview of an exemplary system will first be described. In the exemplary system shown in FIG. 1, a plurality of spaced apart remote GPS sensors, (RGSs 22), form a network and generally define the extent of a theater 101 of operations in which guidance and navigation to locations therein can have greatly improved precision. In an exemplary embodiment, the RGSs are implemented using NavStrikeII receivers manufactured by the Rockwell Collins Corporation. An RGS 22 contains a GPS receiver and a data processor. Each RGS 22 collects and formats the received GPS satellite signals for retransmission to one or more Central Processing Nodes, CPN 18. Data can be provided from the RGSs 22 to the CPNs 18 (or exchanged between the RGSs 22 and the CPNs 18) via links 103, 105, 107, 109. The links can be implemented in any fashion, including for example by a land line such as Public Switched Telephone Network (PSTN), via a communications network including but not limited to the Internet, via communication satellite, by radio or microwave frequency transmission, or any combination thereof, and via any appropriate data format or communication protocol (e.g. Internet Protocol, and so forth). In an exemplary embodiment the formatting is merely sufficient to convey the data efficiently, so that the RGSs 22 can be relatively simple and inexpensive devices, so that more complex (and more sensitive) analysis is performed by CPNs at secure and resource-abundant locations.

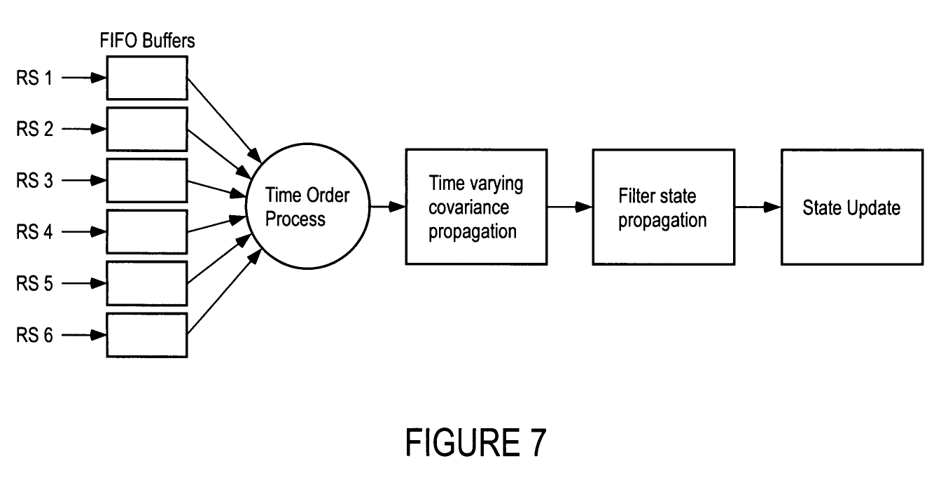

In an exemplary embodiment where the CPN 18 filters data from the RGSs 22 to discern and difference error(s) in the data, the data from the RGSs 22 is buffered and then re-ordered at the cost of latency and non-synchronized measurement intervals, and a varying filter covariance propagation interval is used to update the filter. For example, a FIFO (first-in, first-out) buffer is provided for each RGS 22, data from the buffers is provided to a time-order process which re-orders the data which are then provided to a time-varying covariance propagation processing block. Output of the time-varying covariance propagation processing block is provided to a filter state propagation block, and output from the filter state propagation block is then used to update states of the filter. FIG. 7 illustrates this procedure.

The CPN 18 computes GPS systematic errors and provides theater wide GPS corrections (collectively referred to as correction data) to be transmitted to mobile precision navigation units (PNUs). This correction data is formatted and can be transmitted to users over a non-LOS limited satellite communication link. The corrections from the CPN 18 can be used by any number of Precision Navigation Units (PNUs) that operate in the theater approximately defined by the positions of the RGS set.

Each PNU uses the GPS correction data from the CPN 18 to correct GPS data received by the PNU from the GPS 16 satellites. The corrected GPS data is then used to generate more accurate GPS position and velocity determinations for the current location relative to the earth. This precise navigation information can be applied to both fire control targeting platforms and weapon system guidance platforms. Since vehicles guided by a PNU need no other navigation or targeting aid, expensive terminal seeker equipment is not required, which in turn eliminates the dependence upon favorable weather conditions.

The various principles employed in the invention will now be described in greater detail in connection with the following exemplary embodiments.

FIG. 1 schematically illustrates a situation in which a precision guided munition (PGM) or weapon 10 is being precisely guided to a target 12. The targeting of the weapon 10 is carried out by loading coordinates of the target 12, expressed for example in the WGS (World Geodetic System) 84 reference frame, prior to weapon launch. The coordinates of the target 12 may be ascertained in numerous ways.

One exemplary method of ascertaining target coordinates employs an airborne fire control platform 14. The fire control platform 14 determines the target location 12, by adding a measurement of the relative position of the target 12 with respect to the fire control platform 14, to a precise, absolute position of the fire control platform 14. The absolute position of the fire control platform can for example be provided by a PNU assisted by the herein-described correction techniques, mounted on the fire control platform 14.

In accordance with the present invention, correction data are calculated at a central processing node (CPN) 18, and provided to each PNU. In the illustrated example, the correction data are relayed to each weapon 10 and fire control platform 14 by means of a communications satellite, SATCOM 20.

In an exemplary embodiment, at least three RGS 22 are required to form the network of GPS sensors and at least four of the same GPS satellites must be received by all the RGS in the network. Given the geometry of the GPS constellation the RGS 22 can be located at relatively great distances from each other, for example a thousand miles or more. This approach addresses operational requirements for providing navigation and guidance information to GPS sensors (e.g., ships at sea), combined within a large and often hostile theater of operations.

In an exemplary embodiment the location of each RGS 22 is precisely surveyed and known to the CPN 18. Since the CPN 18 knows the true locations of the RGS 22, the CPN 18 can process the GPS data from the RGS 22 network and determine or estimate errors in the GPS satellite broadcast ephemeris data and each GPS satellite's clock bias. In a preferred embodiment, the RGS 22 employs a dual frequency, L1 and L2, GPS receiver. The dual frequency approach allows calculation in the RGS 22 for the ionospheric delay inherent in the GPS signal and this compensation is reported back to the CPN 18 so that the CPN can relay the ionospheric delay calculated by the RGS 22 to a PNU in an area affected by that ionospheric delay, or can estimate ionospheric compensation parameters that may be used by the PNU. This feature can be useful in the case where the PNU is only equipped with a less expensive single frequency GPS receiver, or where the PNU is subject to interference such as jamming that prevents it from using L1 and L2 to estimate ionospheric delay based on frequency-dependent refractive effects.

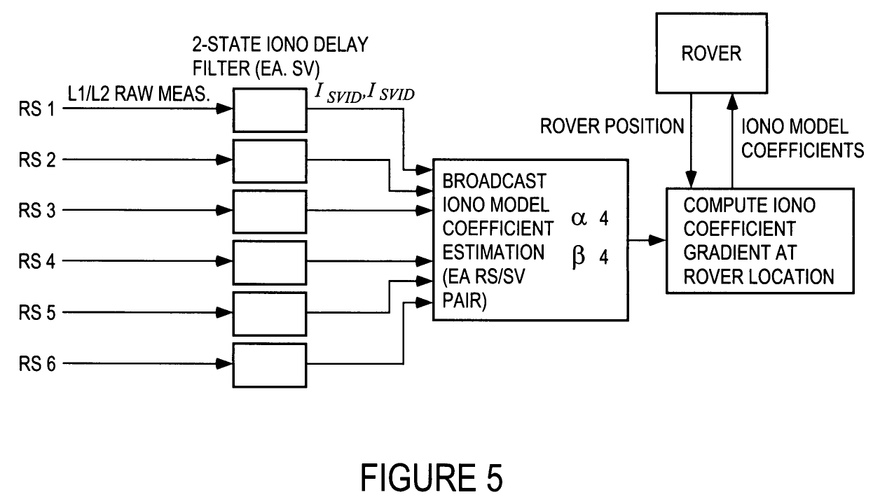

In particular, when receiver operation is limited to single-frequency mode due to jamming and/or receiver limitations, exemplary embodiments of the present invention use ionospheric data collected by the RGSs 22 to estimate an ionospheric correction for a rover or mobile unit (e.g., the PGM 10 and Fire Control Platform 14 shown in FIG. 1) that is based on real-time data instead of an inaccurate satellite-broadcast mathematical model that the rover defaults to when in stand-alone (e.g. single frequency) mode. As shown for example in FIG. 5, dual frequency data can be collected from the RGSs 22, and then smoothed using a 2-state Kalman filter to reduce localized frequency-dependent delays. The resulting data can then be used to improve the satellite-broadcast ionospheric delay model coefficients for each remote site, for example to a site or area specific or local to the rover's geographic position. If the CPN 18 is in communication with any rovers which are unable to track dual-frequency (such as rovers experiencing jamming), then the CPN 18 uses the estimated ionospheric delay model coefficients from the remotes to generate a set of rover ionospheric delay coefficients that have been improved over the broadcast coefficients. These improved coefficients are then transmitted to the rover and used by the rover software in the same manner as a satellite-broadcast coefficient. This gives the rover capability to maintain dual-frequency performance even in conditions where dual-frequency tracking is not possible.

In an exemplary embodiment the CPN 18 also calculates tropospheric delay parameters based on current weather data, using a more accurate model and/or more accurate data that result in a more accurate estimation of tropospheric delay than that calculated by a PNU- or RGS-receiver's built in tropospheric model. The CPN 18 itself can use the ionospheric and tropospheric delay parameters to compensate the RGS data before using them in the estimation process. For example, in an implementation where an RGS's receiver estimates and provides ionospheric and/or tropospheric correction in the signals it sends to the CPN 18, the CPN can remove those corrections before using the data. The CPN 18 can replace the RGS's corrections with more accurate corrections. The estimates computed by the CPN 18 can be formatted to generate the GPS correction data that are valid over the entirety of the theater of operations. Where local conditions such as ionospheric and tropospheric conditions vary within the theater of operations, The CPN 18 can generate different corrections for different local areas, and can transmit or broadcast all the corrections (with appropriate labels, tags or other identification) to all parts of the operations theater so that a PNU that generally knows its own location can select or filter corrections that apply to its local area from among the plurality of corrections provided by the CPN 18. In an exemplary embodiment, the CPN 18 be provided with a location of the PNU and can send corrections specific to the PNU's location specifically to the PNU.

Thus, the CPN 18 can generate and apply accurate estimations of tropospheric corrections to data supplied by the RGSs 22 so that the error corrections it broadcasts to space segment data (satellite vehicle clock bias/error, ephemeris error, etc.) are more accurate, and can also provide weather data to rovers so the rovers can accurately estimate tropospheric delay effects at the rover locations. Since the error the CPN 18 detects between the location calculated by an RGS 22 and the RGS's actual location is a composite of errors from multiple sources, accurately estimating the error contribution of tropospheric delay at the RGS enables the CPN to estimate remaining error (which may apply to a larger area surrounding the RGS, e.g. satellite vehicle clock error and ephemeris error) in the RGS data more accurately and therefore provide more accurate correction data to rovers. Thus weather data at the RGS can be used by the CPN to first of all correct data from the RGS and thereby improve quality of measurements from the RGS and necessary corrections.

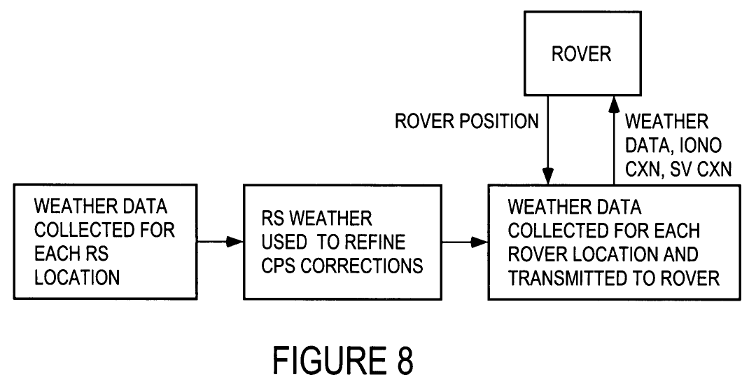

In other words, weather data can be obtained for each remote site location (e.g. RGS 22) as well as at the locations of any rovers (e.g. PGM 10, Fire Control Platform 14) and used by the CPN 18 (e.g, by an Extended Kalman filter in the CPN 18, as described herein) to first of all correct the data from the remote sites (e.g. RGSs 22), and thereby improve the quality of the remote measurements and resulting corrections provided by the precision navigation (PNAV) system described herein. If any rovers are in two-way communication with the master (e.g. CPN(s) 18), the master can use the two-way communication system to determine the location of the rover and sends appropriate weather data to the rover. The rover can then use data regarding weather local to the rover together with correction data from the CPN (e.g., satellite position and satellite clock error, which are common to all GPS receivers tracking that satellite) and also ionospheric correction data supplied by the CPN (in the event the rover is unable to track dual-frequency) to correct its GPS pseudorange measurement and generate a much improved position solution over conventional stand-alone GPS. FIG. 8 shows an exemplary process whereby weather information is provided to a rover or PNU.

In an exemplary embodiment, the minimum footprint on, or volume within, the operations theater over or within which embodiments of the present invention are useful can be generally defined RGSs 22 that circumscribe the operations theater. For example, three RGSs can define a footprint.

GPS correction data generated by the CPN(s) 18 can be transmitted to the PNU in the weapon 10 and also to a fire control platform 14 that is handling or aiding the weapon 10, before the weapon 10 and/or the fire control platform 14 will need to use the data (e.g., before the weapon 10 is launched or activated). The correction data can be conveyed from the CPN 18 to the weapon 10 and fire control platform 14 via a communication satellite (e.g. SATCOM 20), as in the illustrated in FIG. 1, so that line-of-sight communications between the CPN 18 and the weapon 10 and fire control platform 14 are not required. The GPS correction data from the CPN 18 can enable the fire control platform 14 to more accurately identify the location of the target 12 as well as its own location, and thereby more accurately deliver the weapon 10 to the target 12.

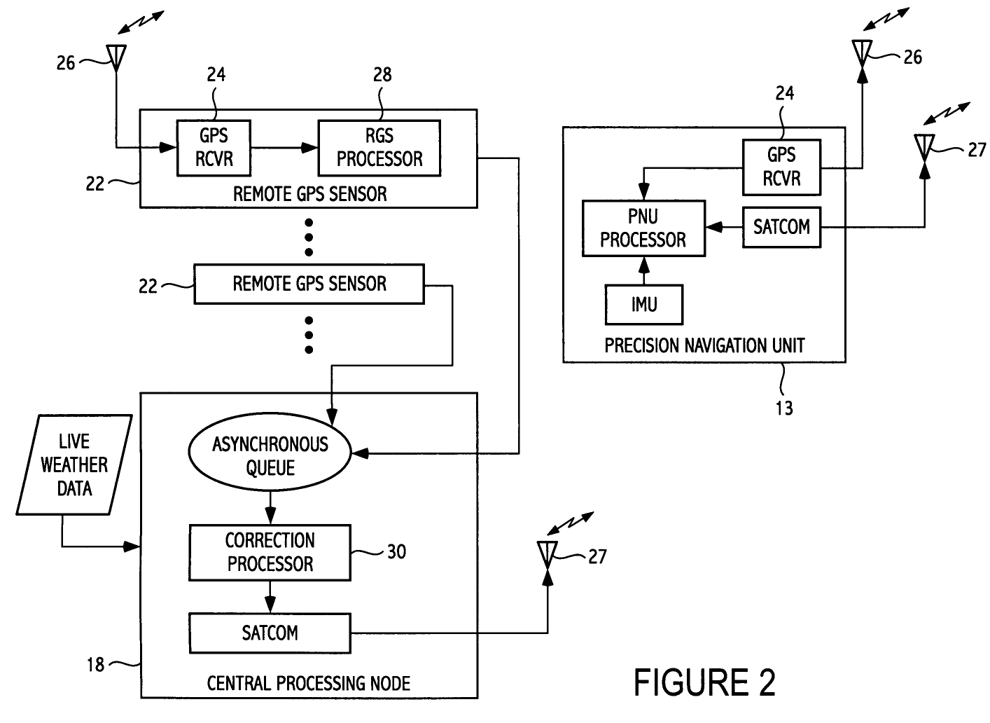

The present invention will now be discussed in more detail with reference to FIG. 2, which is a block diagram of the CPN 18 and RGS 22. Each RGS 22 employs a GPS receiver 24. In an exemplary embodiment of the invention, each GPS receiver 24 uses a Selective Availability/Anti-Spoofing Module (SAASM) and is capable of receiving P(Y) GPS satellite signals in both the L1 and L2 frequency bands that are employed for GPS satellite transmissions. However, such a receiver may be unable to time-synchronize its output with the output of another such receiver.

In another exemplary embodiment of the invention, an antenna system 26 that is employed by the RGS's GPS receiver 24 comprises an interference rejection antenna of the type disclosed in commonly assigned U.S. application Ser. No. 09/902,095, filed Jul. 11, 2001 [Attorney Docket 017750-328].

The satellite signals from the GPS satellites 16 are received at the RGS 22 and are provided to the RGS's processor 28. The purpose of the reference sensor processor 28 is to format output data for transmission to the CPN 18. The GPS data includes both pseudorange and delta pseudorange measurements for each of the GPS satellites 16 that are within line-of-sight of the RGS 22. This data is transmitted from the RGS 22 to the CPN 18 on a regular basis, for example, once a second. The data from each of the RGS 22 are queued up based on the time tags of the data, and the data are processed sequentially until they are consumed. If data from an RGS 22 is late by the time the CPN 18 pulls it from the queue to process it, meaning that data with newer time tags than the data in question has already been processed, then the late data are discarded. This method allows for asynchronous operation of the GPS receivers in the RGS network. This feature simplifies the system, and provides flexibility because individual RGSs 22 can be easily and independently added or omitted from the system without disrupting operation of the system, and allows each RGS 22 to operate independently according to its capability.

In an exemplary embodiment, the CPN 18 contains a Correction Processor 30 as shown in FIG. 2 that decodes the data stream of signals received from the RGSs 22 and provides the decoded data to filter, for example a Kalman filter. The Kalman filter calculates a set of corrections for each satellite measurement by computing the difference between the estimated satellite position and the known position of the RGS 22, and then differencing this estimated range with the GPS pseudorange. A similar process using estimated range rate is differenced with the pseudo deltarange.

The CPN 18 processing required to create the GPS Corrections is described here. The various parameters referred to in the following equations are all defined in the Appendix, which is presented at the end of this description.

In an exemplary embodiment, the basis of the CPN 18 processing is an Extended Kalman filter. This filter is used to estimate the errors from which the GPS corrections are generated. The filter states and their definitions are now described. The RGS 22 clock bias and the RGS 22 clock bias rate for the GPS receiver of each RGS 22 are estimated. The Kalman filter states associated with an RGS 22 are defined as:

$${X}_{RGS} = [ \begin{matrix}{b}_{RGS} \\ {\dot{b}}_{RGS}\end{matrix} ]$$

The GPS satellite position error and GPS satellite clock bias for each GPS satellite are estimated and passed to the PNU 13, (for example via a broadcast from the CPN 18 to all PNUs 13 in the operations theater via any effective communication link or communication method), to correct the GPS constellation at the PGM 10 or Fire Control Platform 14. GPS line of sight (LOS) dependent biases are estimated to give the filter the necessary degrees of freedom to separate GPS satellite ephemeris errors from biases associated with each RGS.

Thus, via the Extended Kalman filter implementation, the CPN 18 can differentiate between local errors at each remote site (e.g. RGS 22) that are present in all measurements (e.g., receiver clock errors) and individually in each satellite being tracked (line of sight biases). Remaining errors that are observed in a satellite at each tracking remote station (e.g. RGS 22) are the space segment errors, and are transmitted to rovers or weapons (e.g. PGM 10, Fire Control Platform 14) as satellite position and clock corrections. The inclusion of these states gives the system increased flexibility over other systems that rely on all remote receivers delivering data at the same instant in time (e.g., synchronously).

LOS dependent bias states are grouped with the GPS satellite states for bookkeeping convenience. The states associated with a satellite are defined as:
X_{SV}_{ⱼ}=[Δr_{SV}_{ₓ}^{ECEF}Δr_{SV}_{_{y}}^{ECEF}Δr_{SV}_{ₓ}^{ECEF}b_{SV}b_{i,j}b_{2,j}b_{3,j}b_{4,j}b_{5,j}b_{6,j}]^{T}

The filter combines data from all the remote stations to form estimates of the errors in the GPS constellation. In an exemplary embodiment the CPN 18 handles up to six RGS 22 and sixteen GPS satellites simultaneously, and the following filter states are provided:

| State Name | States per SV | States per RGS | Total States |
|---|---|---|---|
| SV Position Error | 3 | 0 | 48 |
| SV Clock Error | 1 | 0 | 16 |
| RS Clock Phase | 0 | 1 | 6 |
| RS Clock Frequency | 0 | 1 | 6 |
| LOS Bias Residual | 6 | 16 | 96 |
| Total | 10 | 18 | 172 |

Those skilled in the art will recognize that the CPN 18 can be configured to handle any number of RGSs 22 and GPS satellites simultaneously. As previously mentioned, in an exemplary embodiment there are at least three RGSs and at least four common GPS satellites that the RGSs can hear.

The CPN 18 can indicate its status to an operator and provide an indication of the quality of its estimates of the GPS constellation errors to the weapon.

Since many GPS receivers available for use in the RGS such as the NavStrikeII receiver use a relatively simple tropospheric delay compensation model, in accordance with another aspect of the invention there is provided a method to significantly reduce the tropospheric delay errors.

In an exemplary embodiment, a simple model-based tropospheric delay compensation like that computed in the RGS's 22 GPS receiver 24 is computed by the CPN 18, and is then subtracted from the received RGS GPS receiver's output data (which includes a tropospheric correction added by the RGS) to thereby remove the RGS's tropospheric correction. The CPN 18 then determines a more accurate tropospheric correction using local weather data (e.g. live or current weather data, seasonal weather data, or historical weather data). The CPN 18 applies the weather data as input to the well known Black & Eisner tropospheric delay model to compute a more accurate value for the tropospheric delay at each RGS 22. In an exemplary embodiment, this more accurate tropospheric delay is added back to the data received from that RGS GPS receiver by the CPN 18 processing before the GPS data is passed to the CPN's 18 Kalman filter process. In an exemplary embodiment the parameters used in the Black & Eisner delay model are also sent to the PNU 12. For example, the parameters can include weather data that apply to the local area of the PNU 12, so that the PNU 12 can apply the Black & Eisner model to data for weather local to it to obtain an accurate tropospheric delay estimate at the location of the PNU 12. Thus, the weather data to allow for an accurate tropospheric delay compensation during the execution of a mission to be carried out by a PGM 10 or a Fire Control Platform 14. The CPN 18 can for example receive weather data that applies to all or part of the operations theater, from any source, including for a database that archives historical weather data for geographic locations within the operations theater, from weather information services external to the operations theater, from weather sensors within the operational theater, and so forth.

System Architecture Description

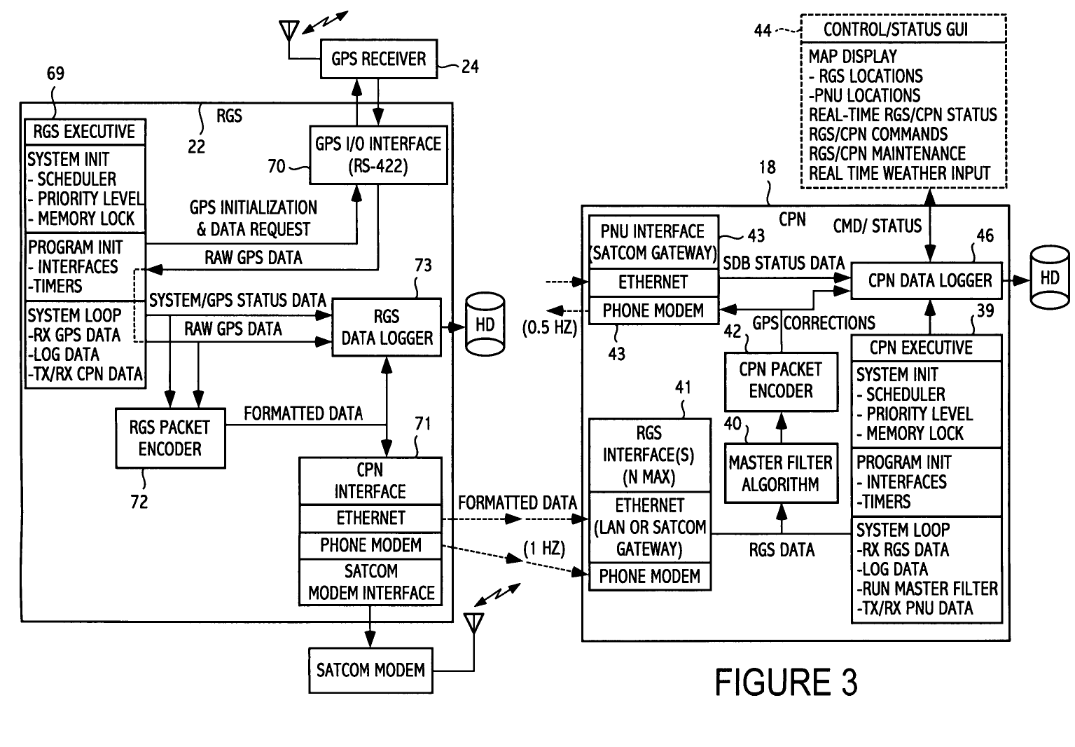

Presented next are specific architecture and control functions for implementing the CPN 18 processing functions and the RGS 22 collection functions. FIG. 3 presents a simplified flow diagram illustrating exemplary processing and interfaces of the CPN 18 and RGS 22. The top level processes that make up the CPN 18 include the following: CPN Executive 39, Master Filter Algorithms 40, RGS Interface 41, CPN Packet Encoder 42, PNU Satcom (satellite communications) Interface 43, User Control/Status Graphical User Interface (GUI) 44 and CPN Data Logger 46. Top level processes of the RGS 22 include the following: RGS Executive 69, GPS I/O Interface 70, CPN Interface 71, RGS Packet Encoder 72, and RGS Data Logger 73.

The CPN Executive 39 handles all CPN 18 processing initialization, including the Processing Kernel, system configuration parameters, Master Filter parameters, and communication channel initializations; and manages run time functions, including handling interrupts, and timers. The Master Filter Algorithms 40 process the data received from the reference sensors (e.g. RGSs 22) and calculate the GPS correction for the GPS satellites over the area of interest covered by the reference sensors as described herein. The RGS Interface 41 monitors and controls the flow of data between the multiple RGS 22 sensor units and routes the data to the Master Filter Algorithms 40. The communication channel between the CPN 18 and the RGS 22 units may be Ethernet (Internet), PSTN (Phone) modem, or Satcom modem. The RGS Interface 41 processing determines the best available communication channel to be used for each RGS 22. The CPN Packet Encoder 42 formats the output of the Master Filter Algorithm 40 into data packets suitable for transport by the PNU Interface 43. The same data packet is transported over all of the different physical interfaces. The PNU Interface 43 manages the communication channels between the CPN 18 and the PNU 13 (which can be multiple connections simultaneously present, for example one for each PNU 13 desiring correction services). The Control/Status GUI 44 provides real-time management control and status information of the Master Filter Algorithms 40 and the connected PNU 13. The CPN Data Logger 46 generates, stores, and manages log file history of selected CPN data and status, including all interface traffic to the PNU 13 and RGS 22.

The RGS Executive 69 handles all RGS 22 processing initialization, including the Processing Kernel, system configuration parameters, GPS Receiver parameters, and communication channel initializations; and manages run time functions, including handling interrupts, and timers. The GPS I/O Interface 70 initializes, manages, and operates the communication channel with the GPS Receiver 24. The CPN Interface 71 establishes a communication channel with the CPN and manages the packet data flow. The RGS Packet Encoder 72 formats the output of the GPS Receiver 24 into data packets suitable for transport by the CPN Interface 71. The RGS Data Logger 73 generates, stores, and manages log file history of selected RGS data and status, including all interface traffic to the CPN 18 and GPS Receiver.

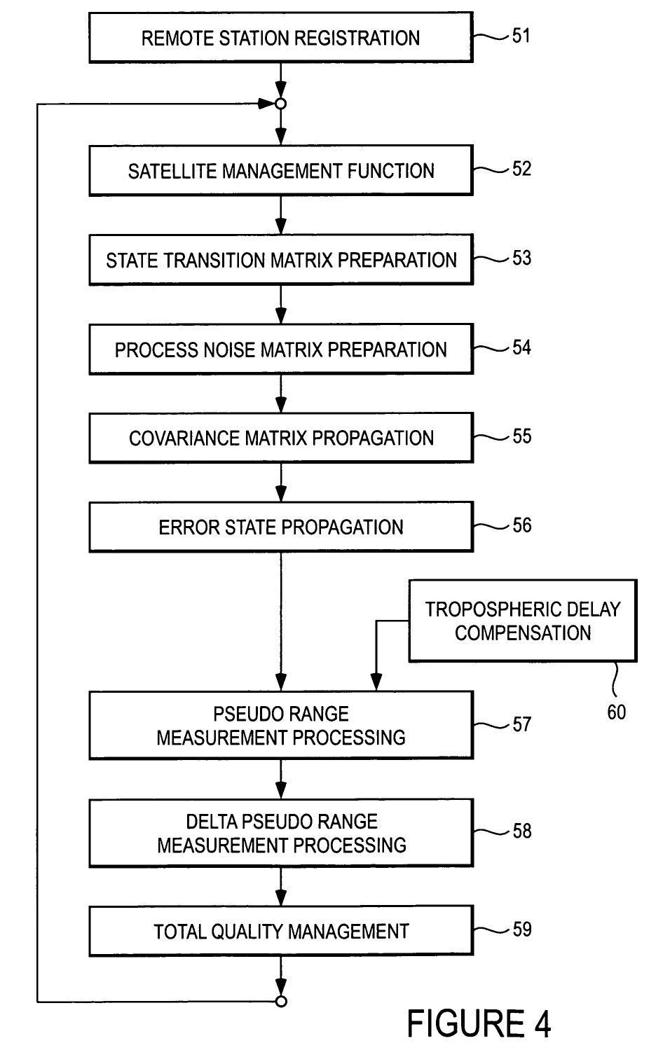

FIG. 4 is a simplified block diagram illustrating the GPS Correction Algorithm 40 processing within the CPN 18. In an exemplary embodiment, the GPS Correction Algorithm 40 is a Kalman Filter. FIG. 4 represents the executive function of this portion of the CPN 18 processing. Each functional block shall now be described and equations shall be presented where required for clarity.

The REMOTE STATION REGISTRATION 51 function enters an RGS into the set of RGS's to be processed. Each RGS is assigned a unique index from 1 to N. This index is used as an address for locating data associated with a particular RGS within the filter. This function verifies that the RGS has been surveyed and contained in the data base of RGS's.

The SATELLITE MANAGEMENT 52 function examines the message from each RGS and it configures the filter based on what satellites are being reported and what their status is. If a satellite currently being tracked by the CPN 18 has not been updated for some time say 60 seconds its track will be removed from consideration. If a satellite that is not being tracked shows up in the list from an RGS it will be added to the set being tracked. If this function detects a change in the broadcasted navigation message from a satellite, this satellite's track is reset.

The STATE TRANSITION MATRIX PREPARATION 53 function populates the Kalman filter's state transition matrix. The RS clock bias and SV position corrections are modeled as constants. The RGS 22 clock bias rate, the SV clock bias and the LOS dependent biases are modeled as first order Markov processes. Finally, the RGS 22 clock bias rate integrates into the RS clock bias. Only the active RGS's and SV's locations in the Φ matrix shall be populated. The diagonals for each active RGS and SV are shown below:

$$\text{Define:} {Φ}_{{RGS}_{i}} = [ \begin{matrix}1 & Δ t \\ 0 & {ⅇ}^{\frac{- Δ t}{{τ}_{RGS}}}\end{matrix} ]$$

$$\text{Define:} {Φ}_{{SV}_{j}} = diag [ \begin{matrix}1 & 1 & 1 & {ⅇ}^{\frac{- Δ t}{{τ}_{SV}}} & {ⅇ}^{\frac{- Δ t}{{τ}_{LOS}}} & {ⅇ}^{\frac{- Δ t}{{τ}_{LOS}}} & {ⅇ}^{\frac{- Δ t}{{τ}_{LOS}}} & {ⅇ}^{\frac{- Δ t}{{τ}_{LOS}}} & {ⅇ}^{\frac{- Δ t}{{τ}_{LOS}}} & {ⅇ}^{\frac{- Δ t}{{τ}_{LOS}}}\end{matrix} ]$$

The PROCESS NOISE MATRIX PREPARATION 54 function populates the process noise matrix Q. Once again, the RGS clock bias and SV position corrections are modeled as constants. The RGS clock bias rate, the SV clock bias and the LOS dependent biases are modeled as first order Markov processes. Only the active RS's and SV's locations in the Q matrix shall be populated.

$$\text{Define:} {Q}_{{RS}_{i}} = [ \begin{matrix}0 & {σ}_{{b}_{RS}}^{2} ( 1.0 - {ⅇ}^{\frac{- 2 Δ t}{{τ}_{RS}}} )\end{matrix} ]$$

$$\text{Define:} {Q}_{SV clock bias} = {σ}_{SV clock bias}^{2} ( 1.0 - {ⅇ}^{\frac{- 2 Δ t}{{τ}_{SV}}} ) ;$$

$${Q}_{LOS} = {σ}_{LOS bias}^{2} ( 1.0 - {ⅇ}^{\frac{- 2 Δ t}{{τ}_{LOS}}} )$$

$$\text{Define:} {Q}_{{Sat}_{j}} = [ \begin{matrix}0 & 0 & 0 & {Q}_{SV} & {Q}_{LOS} & {Q}_{LOS} & {Q}_{LOS} & {Q}_{LOS}\end{matrix} ]$$

$$\text{Define} Q = diag [ [ {Q}_{{RS}_{i}} ] … [ {Q}_{{SV}_{j}} ] … ] ;$$

$$for the active RS ' s and SV ' s only !$$

The COVARIANCE MATRIX PROPAGATION function 55 integrates the Kalman filter's covariance matrix using the state transition matrix and process noise matrix from above. The ERROR STATE PROPAGATION function propagates the estimates for each RGS;

$${b}_{{RS}_{i}} = {b}_{{RS}_{i}} + {\dot{b}}_{{RS}_{i}} Δ t$$

$${\dot{b}}_{{RS}_{1}} = {ⅇ}^{\frac{- Δ t}{{τ}_{RS}}} {\dot{b}}_{{RS}_{i}}$$

and each Satellite:

$${b}_{{SV}_{j}} = {ⅇ}^{\frac{- Δ t}{{τ}_{SV}}} {b}_{{SV}_{j}}$$

$${b}_{{LOS}_{j}} = {ⅇ}^{\frac{- Δ t}{{τ}_{LOS}}} {b}_{{LOS}_{j}} ; for all active LOS biases$$

The RGS 22 GPS measurements are buffered by RGS 22 for processing by the CPN 18, and processed in time sequential order based on GPS time of measurement. The next measurement to be processed is determined by examining the time tag for the next measurement in each remote station buffer, provided that each buffer has at least one measurement. If any of the remote station buffers are empty, then the selection of the next measurement is delayed until there are no empty buffers, or the maximum delay time has been exceeded. Any measurements which occur for times earlier than what is currently being processed are discarded. The time sequential processing of the GPS measurements is critical to successful filter operation, while the correction filters are tolerant of delays in processing on the order of several seconds.

The PSEUDO RANGE MEASUREMENT PROCESSING function 57 processes the GPS pseudorange measurements reported by an RGS 22. The pseudorange measurements are processed sequentially. The following processing is executed once for each satellite reported in an RGS 22 message:

The estimated LOS vector from the reference sensor 22 to the satellite is computed by:
r_{SVRS}^{ECEF}=[r_{SV}_{ⱼ}^{ECEF}(t_{End})−Δr_{SV}_{ⱼ}^{ECEF}]−r_{RS}_{ᵢ}^{ECEF}

The unit LOS vector is computed by:

$${u}_{SVRS}^{ECEF} = \frac{{r}_{SVRS}^{ECEF}}{\vert {r}_{SVRS}^{ECEF} \vert}$$

The H matrix is populated based on the indices within the Kalman Filter of the RGS and Satellite pair being processed. The pseudorange error measurement model is:
[u_{SVRS}^{ECEF}]^{T}[Δr_{SV}_{ⱼ}^{ECEF}]+b_{SV}_{ⱼ}−b_{RS}_{ᵢ}+b_{LOS}_{_{i,j}}

The Reference Sensor receiver noise variance is computed as:
σ_{PR}²=σ_{LOS PR}²+44.4243+4.6343e−05 C_{No}⁴−0.0058 C_{No}³+0.2715 C_{No}²−5.6249 C_{No}

At this point in the PSEUDO RANGE MEASUREMENT PROCESSING 57 function, the TROPOSPHERIC DELAY COMPENSATION 60 function is invoked. As discussed herein, many GPS Satellite Receivers use a relatively simple tropospheric delay compensation model. To improve performance, in exemplary embodiments of the invention a more accurate tropospheric correction is utilized. The NavStrike II receivers used in an exemplary embodiment of the RGS 22 serve as an example of a receiver that uses a simple model.

Using the same tropospheric model as used in the RGS 22, a tropospheric delay compensation value for each Satellite reported by a Reference Sensor is computed and subtracted from the corresponding receiver's output for that Satellite. This effectively removes the Reference Sensor's GPS receiver tropospheric correction from the data message. A more accurate tropospheric delay based on current weather conditions or historical weather data is added back to the receiver's output to provide increased accuracy.

The simple tropospheric model in the system demonstration of the present invention is known as the Altshuler and Kalaghan model. The more accurate model used in the present invention is known as the Black & Eisner model. A discussion of these methods may be found in “Global Positioning System: Theory and Applications” by Bradford W. Parkinson and James J., Jr Spilker.

With the tropospheric correction data, the PSEUDO RANGE MEASUREMENT PROCESSING 57 then computes the estimated pseudorange for the Satellite as:
pₑₛₜ=|r_{SVRS}^{ECEF}|−b_{SV}_{ⱼ}+Δbₜᵣₒₚₒ

The PSEUDO RANGE MEASUREMENT PROCESSING 57 function then computes the pseudorange correction for the satellite, Δp, by subtracting the measured pseudorange, obtained from an independent or self survey of the Reference Sensor location, from the estimated pseudorange by:
δp=pₑₛₜ−(pₘₑₐₙₛ−b_{RS}_{ᵢ}+b_{LOS}_{_{i,j}})

The PSEUDO RANGE MEASUREMENT PROCESSING 57 function then computes measurement variance as,

$$S = [ {HPH}^{T} + {σ}_{PR}^{2} ]$$

and the chi squared statistic is computed to test the reasonableness of the measurement.

$${χ}_{PR}^{2} = \frac{δ {p}^{2}}{S} < {χ}_{PR Limit}^{2}$$

The PSEUDO RANGE MEASUREMENT PROCESSING 57 function then computes a quality factor for each Satellite's pseudorange and records the result.

$${m}_{{SQM}_{j}} = {ⅇ}^{- \frac{Δ t}{{τ}_{SQM}}} {m}_{{SQM}_{j}} + ( 1 - {ⅇ}^{- \frac{Δ t}{{τ}_{SQM}}} ) {χ}_{PR}^{2}$$

If the chi squared statistic is less than the initialized limit, the PSEUDO RANGE MEASUREMENT PROCESSING 57 function proceeds with updating the Kalman gain, state vector and covariance of the Kalman filter.

The Kalman gain is computed as:
K=PH^{T}S⁻¹

The state vector based on the gain and measurement is updated as:
δX=Kδp
X=X−δX

and the updated covariance is computed as:
P=[I−KH]P

At this point the PSEUDO RANGE MEASUREMENT PROCESSING 57 function logs a successful update of the pseudorange and the pseudorange correction for this satellite. The data is time stamped with the GPS time and recorded.

The DELTA PSEUDO RANGE MEASUREMENT PROCESSING 58 function processes the deltarange measurements for the satellites whose signals were received for the current reference sensor measurements being processed. These instructions are executed once for each satellite reported by the RGS 22.

The DELTA PSEUDO RANGE MEASUREMENT PROCESSING function 58 first computes the estimate of the LOS vector from an RGS 22 position to the Satellite position at the start of the deltarange interval:
r_{SVRS}^{ECEF}(t_{Start})=(r_{SV}_{ⱼ}^{ECEF}(t_{Start})−Δr_{SV}_{ⱼ}^{ECEF})−r_{RS}_{ᵢ}^{ECEF}

The start LOS vector computed above is unitized by the following process:

$${u}_{SVRS}^{ECEF} ( {t}_{Start} ) = \frac{{r}_{RSSV}^{ECEF} ( {t}_{Start} )}{\vert {r}_{RSSV}^{ECEF} ( {t}_{Start} ) \vert}$$

The DELTA PSEUDO RANGE MEASUREMENT PROCESSING 58 function then computes the estimate of the LOS vector from the RGS position to the Satellite position at the end of the deltarange interval:
r_{SVRS}^{ECEF}(t_{End})=(r_{SV}_{ⱼ}^{ECEF}(t_{End})−Δr_{SV}_{ⱼ}^{ECEF})−r_{RS}_{ᵢ}^{ECEF}

Similarly the end LOS vector is unitized as:

$${u}_{SV RS}^{ECEF} ( {t}_{GPS} ) = \frac{{r}_{SV RS}^{ECEF} ( {t}_{GPS} )}{\vert {r}_{SV RS}^{ECEF} ( {t}_{GPS} ) \vert}$$

The H matrix is populated based on the indices within the Kalman filter of the RGS 22 and Satellite pair being processed. The deltarange error measurement model is:
[u_{SVRS}^{ECEF}(t_{End})−u_{SVRS}^{ECEF}(t_{Start})]^{T}Δr_{SV}_{ⱼ}^{ECEF}−\dot{b}_{RS}_{ᵢ}Δt

The DELTA PSEUDO RANGE MEASUREMENT PROCESSING 58 function then computes the estimated deltarange based upon the measurement as:
Δpₑₛₜ=|r_{SVRS}^{ECEF}(t_{End})|−|r_{SVRS}^{ECEF}(t_{Start})|

The DELTA PSEUDO RANGE MEASUREMENT PROCESSING 58 function then computes the deltarange correction value, δΔp by subtracting the measured deltarange, computed from the independent or self survey of the Reference Sensor position, from the estimated deltarange computed from this measurement as:

$$δΔρ = {Δρ}_{est} - ( {Δρ}_{meas} - {\dot{b}}_{Rem} Δ t )$$

The measurement variance is calculated as:
S=[HPH^{T}+σ_{DR}²]

and the chi squared statistic is computed to test the reasonableness of the measurement as:

$${χ}_{DR}^{ 2} = \frac{{δΔρ}^{ 2}}{S} < {χ}_{DR Limit}^{ 2}$$

If the chi squared statistic is less than the initialized limit, the DELTA PSEUDO RANGE MEASUREMENT PROCESSING 58 function then proceeds with the remainder of the deltarange processing.

The Kalman gain is computed as:

$$K = {{PH}^{ T} [ {HPH}^{ T} + {σ}_{DR}^{ 2} ]}^{- 1}$$

An update to the state vector based on the gain and measurement is computed as:
δX=Kδp
X=X−δX

And the covariance matrix is updated as:
P=[I−KH]P

At this point the DELTA PSEUDO RANGE MEASUREMENT PROCESSING 58 function logs a successful update of the deltarange and the deltarange correction for this satellite. The data is time stamped with the GPS time and recorded.

The TOTAL QUALITY MANAGEMENT 59 function computes an overall integrity measurement for the Kalman filter. The position error of each RGS 22 with respect to its surveyed position is entered into this common calculation to measure the overall health of the CPN 18.

The TOTAL QUALITY MANAGEMENT 59 function computes a Position, Velocity and Time (PVT) solution using the corrections calculated by the Kalman filter and the data from the current RGS message. The TOTAL QUALITY MANAGEMENT 59 function computes the magnitude of the position error of this Reference Sensor's PVT with respect to the surveyed RS location as:
|Δr_{PVT}_{ᵢ}|=|r_{PVT}_{ᵢ}^{ECEF}−r_{RS}_{ᵢ}^{ECEF}|

The TOTAL QUALITY MANAGEMENT 59 function computes a normalized-position error magnitude by multiplying the computed PVT by

$$\begin{matrix}Δ {r}_{norm} = \frac{\vert Δ {r}_{{PVT}_{1}} \vert}{{k}_{TQM} \cdot PDOP} \\ {m}_{TQM} = {ⅇ}^{- \frac{Δ t}{{τ}_{TQM}}} {m}_{TQM} + ( 1 - {ⅇ}^{- \frac{Δ t}{{τ}_{TQM}}} ) ( Δ {r}_{norm} - {m}_{TQM} ) \\ if ( ( Δ {r}_{norm} - {m}_{TQM} ) > 0.0 ) then \\ {m}_{TQM} = Δ {r}_{norm} end if\end{matrix}$$

and compares the result with the desired initialized User Equipment Residual Error (UERE). This performance flag is routed to the Graphical User Interface (GUI) Client Application 44 where the status of the Reference Sensor's performance is displayed for the CPN 18 operator or other logged in users.

The GPS Corrections can be applied directly to the GPS LOS measurements of the end user PNU 13 by different methods. In a first exemplary method, GPS Satellite Position Corrections are subtracted from the satellite position in the GPS LOS data, and the PNAV Satellite Clock Correction is added to the Pseudo Range measurement. Processing of the GPS LOS measurements can then occur in a normal fashion. In a second exemplary method, a dot product of the PNAV Satellite Position Corrections with the current LOS unit vector to the corresponding satellite position (in ECEF frame) is performed, and the resulting value is added to the Pseudo Range measurement, and then add the PNAV Satellite Clock Correction to the Pseudo Range measurement. In this second method, only the Pseudo Range is changed, but the current observation position must be estimated.

The IODE (Issue of Data Ephemeris) of the PNAV Corrections must match the current IODE of the GPS LOS measurements. If the IODE of the GPS LOS measurements changes, the older PNAV Corrections can still be used by computing the satellite positions, used in the GPS LOS measurement processing, from GPS Ephemeris data with the same IODE as the PNAV Corrections. This process allows for continuous operation during IODE changes, and also allows for continued operation for several minutes after PNAV Corrections are no longer updated. If PNAV Corrections are passed from an aircraft to a weapon prior to launch or separation of the weapon from the aircraft, the weapon could continue to perform Precision Navigation for a time period (e.g., approximately 15 minutes) after separation from the aircraft, by using current GPS LOS measurements, stored PNAV Corrections, and stored matching Ephemeris data.

In particular, the GPS JPO Control Segment periodically updates the satellite ephemerides (orbital parameters that are used to calculate satellite positions at any instant in time) in order to maintain adequate performance for stand-alone GPS receivers. These IODE (Issue of Data, Ephemeris) updates typically occur every two hours, and when they occur any previous estimates of satellite position and clock errors are not valid for the new IODE. When a new IODE occurs, some time is necessary for the MSF (Master Station Filter, e.g., the Extended Kalman Filter described herein and implemented within or in conjunction with the CPN 18) to accurately estimate new corrections. During this time (or if the rover has lost connection to the master prior to IODE changeover) the rover must use the old ephemeris data in computing the corrected satellite positions. The PNAV navigation software computes the satellite positions independent of the receiver (which will automatically begin using the new IODE when it is broadcast), and will continue to use the ephemeris for which it has corrections, effectively overriding the receiver that will use the new ephemeris. This technique allows PNAV the flexibility to continue operating at full capability before, during, and after an IODE change, even in the event of a communication dropout between the master station and the rover.

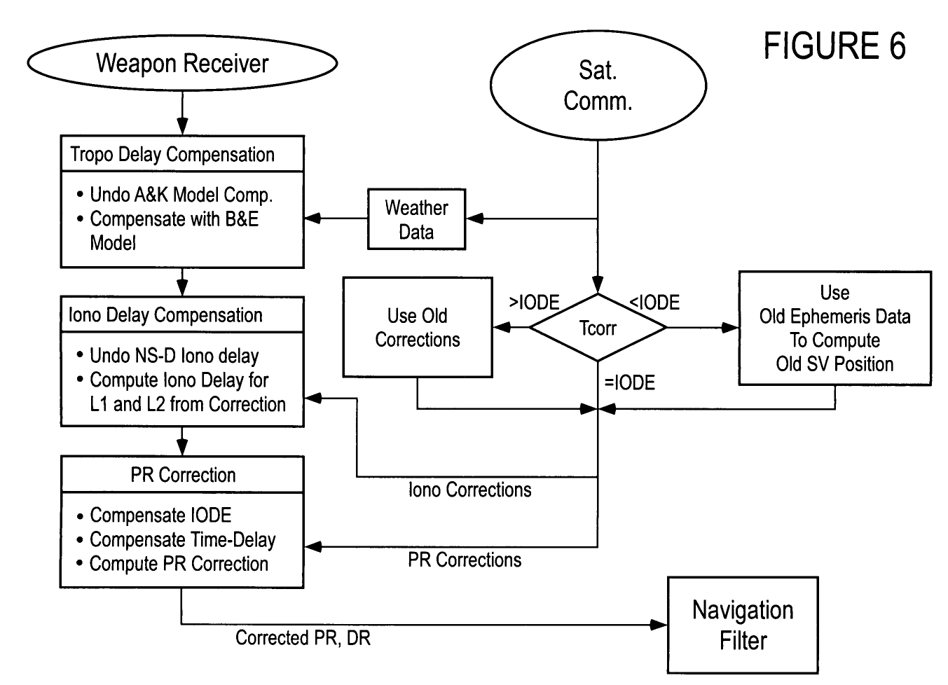

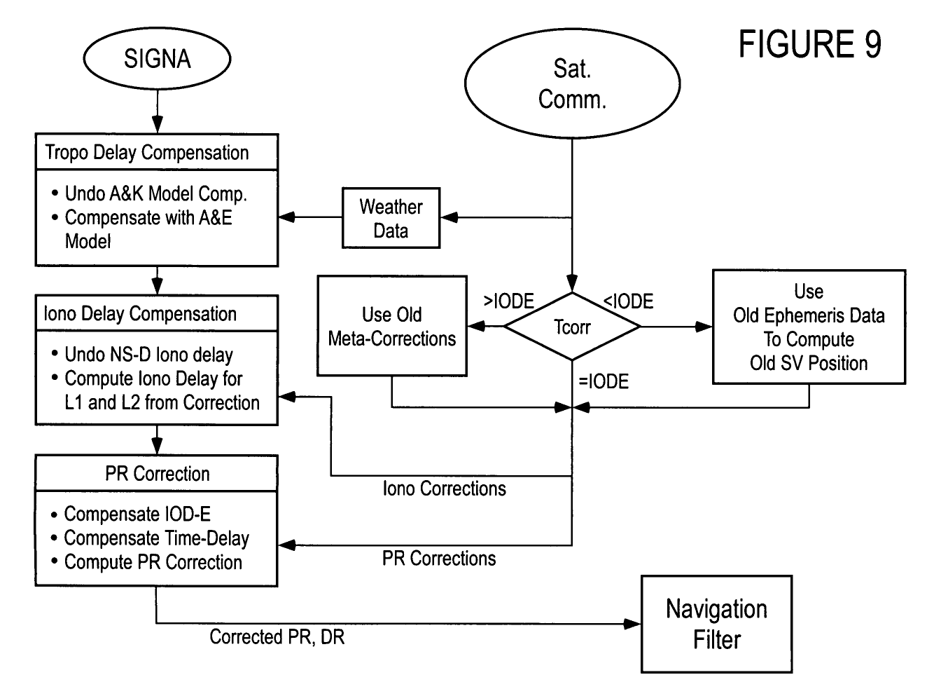

FIG. 6 illustrates an exemplary functional flow of corrections within a rover or weapon, including IODE correction, tropospheric correction, and ionospheric correction, consistent with exemplary embodiments and techniques described herein. FIG. 9 illustrates another exemplary functional flow diagram of corrections and communications involving a rover or weapon.

FIG. 10 illustrates an exemplary embodiment wherein information (e.g. related to GPS corrections) is relayed directly from the CPN 18 to a PNU such as a weapons platform 140 with a weapon 142, and also indirectly from the CPN 18 to one or more PNUs (Precision Navigation Units) in the operations theater, for example the PGM 10 and an airborne weapons platform (e.g. an F-15 Strike Eagle aircraft) 146 bearing a weapon 148 for later release. In particular, FIG. 10 shows the CPN 18 connected to RGSs 22 via communication links 103, 105, 107, 109, and providing correction data to the PNUs 10,146 via a communications satellite 20 and a communications aircraft 144. FIG. 10 shows a communication link 120 between the CPN 18 and the communications satellite (SATCOM) 20, a communication link 122 between the SATCOM 20 and the communications aircraft 144, and a communications link 124 between the communications aircraft 144 and the PNU 146 and a communications link 125 between the communications aircraft 144 and the PNU 10. The links 120, 122, can for example be implemented using Joint Range Extension Relay (JRE) technology capable of conveying data in accordance with the Link-16 standard or protocol, used for example by the U.S. Military. Conventional communication links 130, 132, 134 between the PNU (PGM) 10 and the GPS satellites 16 are also shown.

In accordance with exemplary embodiments and methods described herein, correction data or messages provided by a CPN18 to a rover such as the PGM 10 or the Fire Control Platform 14 can include for example a GPS week, a GPS time, a number of satellite vehicles (SVs), a correction record for each SV that includes Issue of Data Ephemeris, SV position error corrections, SV clock error correction, PR (Pseudo Range) correction integrity index, ionospheric correction and gradients, and ionospheric correction integrity index. The correction data can also include tropospheric model weather data at the rover or mission area such as ground temperature, pressure at ground elevation, relative humidity, and an integrity index.

As variously described herein, GPS system errors can come from multiple sources. Errors from the space segment of the system include GPS satellite vehicle clock error, and orbital position error. In accordance with exemplary embodiments of the present invention described herein, these space segment errors are estimated and corrected via full vector filtering, described for example with respect to the Extended Kalman Filter in the CPN 18. Other errors include propagation errors such as ionospheric delay and tropospheric delay. Ionospheric delay can be corrected by comparing refraction of the L1 and L2 signals and filtering (e.g., decoupled filtering), as variously described herein. Errors having a local source include clock error of a GPS receiver clock, noise at the GPS receiver, and multipath interference or effects at the GPS receiver. These locally-sourced errors as well as the tropospheric delay can be corrected locally at the GPS receiver (e.g. at a remote station such as an RGS 22 or at a rover or weapon such as the PGM 10 or Fire Control Platform 14), as variously described herein. For example, the tropospheric delay can be estimated using local weather data and/or an improved model such as the Black & Eisner model, and receiver clock errors, local noise and multipath errors or effects can be corrected using for example Kalman filtering.

In an exemplary embodiment, only the GPS LOS measurements for which corrections are available are used in the processing of the Navigation solution. If the number of corrected measurements falls below four, then any other available measurements can be used, but their measurement variances can also be raised with respect to the corrected measurements. This allows for graceful operation outside of the PNAV correction envelope.

PNAV Corrections can also be used by a GPS Receiver which does not return GPS LOS measurements. The PNAV Corrections can be transformed into the Pseudo Range LOS domain, using the second method of PNAV Correction processing described above, then formatted into a standard Differential Correction message, and sent to the GPS Receiver. This will result in a more accurate position and velocity solution as calculated by the GPS Receiver.

Graphical User Interface

In an exemplary embodiment, the Control/Status Graphical User Interface 44 provides the following system level capabilities: RGS/PNU Map Location Overlay, RGS/CPN Status and performance Information, RGS/CPN Command Input, RGS/CPN Maintenance Capabilities, and real time Weather Data input. The Map Location Overlay function provides an operator with a display of all RGS locations geographically referenced over a map background to include the entire theater of operations. Additionally, all PNUs with a current connection into the network can be displayed geographically referenced over the map background. Real time health and status information from the RGS and PNU are displayed in additional windows to provide system status and communication channel information. System performance information is displayed on real time continually updated plots for each RGS and PNU. The information includes raw GPS performance and corrected GPS performance, as well as parametric data from each GPS satellite in view of the receiver. Performance data from the CPN Master Filter is also displayed to determine current system performance characteristics.

The GUI sets warning flags to indicate when performance is out of bounds as determined by the Total Quality Management function. The GUI provides the ability to input real time commands into the CPN and RGS to adjust the system for current operating conditions. These commands include GPS Receiver reset, Master Filter reset, and removing specific RGS from the network. Maintenance actions can be performed on the system through the GUI including flushing and resetting log files, loading new software into the GPS receiver or the RGS and downloading the fault logs. Real time weather information including Temperature, Pressure and Humidity is collected from existing weather sites and pulled down over the Ethernet by the GUI for each RGS location. This real time data may be used in the CPN calculations to override the historical data.

### CONCLUSION

From the foregoing, it can be seen that exemplary embodiments of the present invention provide a precision closed loop guidance and navigation system that improves accuracy by reducing both navigation errors and target location errors. These errors are reduced through the use of multiple, widely-spaced remote GPS sensors which receive GPS line-of-sight signals. These signals are provided to a central processing node, which combines them to generate a correction message that covers entire the theatre of operations approximately defined by the location of the remote GPS sensors, and which can include local tropospheric delay corrections. The correction messages are then transmitted to the precision navigation unit users through various communication channels, including for example satellite communications.

The techniques described herein are applicable for various forms of GPS receivers, including commercial versions as well as military versions (which are encoded).

A significant advantage of the present invention lies in the fact that the closed-loop guidance and navigation accuracy is available over a significantly large region. Even though the fire control platform, weapon and target may be widely separated from one another, the large area of coverage provides corrections for them.

The functions, activities and processes described herein, for example the activities of the CPN 18, can be variously performed by hardware devices such as ASICs (Application Specific Integrated Circuits), computing devices such as microprocessors, microcontrollers, computers, computer networks, and so forth. The various functions can be performed by software running in a central or distributed fashion on those devices or resources. The various different functions described herein, can for example be performed by different modules of one or more software programs, and/or can be performed by different software programs, and the software can be run in a central or distributed fashion.

The methods, logics, techniques and sequences described above can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms, and can be implemented using analog techniques, digital techniques, or any combination thereof.

Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

It will be appreciated by those of ordinary skill in the art that the present invention can be embodied in other forms without departing from the spirit or essential characteristics thereof. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Appendix A:
Symbol Table
This table lists the symbols in use throughout the document.

| Symbol | Definition |
|---|---|
| φ | State transition matrix |
| Q | Process noise matrix |
| Q_{RS} | Process noise sub matrix for an RS |
| Q_{SV} | Process noise sub matrix for an SV |
| Q_{sv clockbias} | Markov Process noise for SV clock bias |
| Q_{LOS} | Markov Process noise for LOS dependent |
| | biases |
| u^{ECEF}_{SVRS} | Unit LOS vector from RS to SV |
| σ²_{b}_{_{RS}} | Initial RS clock rate bias variance |
| σ²_{LOSbias} | Initial LOS dependent bias variance |
| σ²_{SV clockbias} | Initial SV clock bias variance |
| σ²_{DR} | Deltarange measurement noise variance |
| σ²_{PR} | Pseudorange measurement noise variance |
| S | Measurement covariance |
| φ_{RS}_{₁} | State transition sub matrix of an RS |
| φ_{SV}_{₁} | State transition sub matrix of an SV |
| K | Kalman gain |
| P | Error state covariance |
| PDOP | Position Dilution of Position |
| K_{TQM} | Normalization for factor of TQM |
| Δt | Time since last RS processed |
| t_{End} | Time at the end of the Deltarange interval |
| t_{Start} | Time at the start of the Deltarange interval |
| t_{GPS} | GPS time |
| t_{Expire} | Time limit to expire an SV that is not being |
| | updated |
| τ_{RS} | RS clock bias rate Markov time constant |
| τ_{SV} | SV clock bias Markov time constant |
| τ_{LOS} | LOS dependent bias Markov time constant |
| τ_{SQM} | Time constant of SQM filter |
| τ_{TQM} | Time constant of TQM filter |
| Δr^{ECEF}_{SV} | SV position correction |
| r^{ECEF}_{RS}_{₁} | Surveyed position of RS |
| δr^{ECEF}_{SV}_{₁} | SV position error for the x coordinate |
| δr^{ECEF}_{SV}_{_{y}} | SV position error for the y coordinate |
| δr^{ECEF}_{SV}_{_{z}} | SV position error for the z coordinate |
| r^{ECEF}_{SVRS} | LOS vector from an RS to an SV |
| r^{ECEF}_{SV}_{ⱼ} | Satellite position as reported by the RS's |
| | from broadcast ephemeris. |
| Δr^{ECEF}_{SV}_{ⱼ} | Correction to the satellite position |
| ρₑₛₜ | estimate of pseudorange |
| δρ | Pseudorange error measurement |
| ρₘₑₐₛ | Pseudorange reported by RS's |
| Δρₑₛₜ | estimate of deltarange |
| δΔρ | Deltarange error measurement |
| Δρₘₑₐₛ | Deltarange reported by RS's |
| Δr_{PVT}_{ᵢ} | Position error of PVT solution of an RS after |
| | PNAV corrections are applied to receiver output |
| r^{ECEF}_{PVT}_{ᵢ} | PVT solution of an RS after PNAV |
| | corrections are applied to receiver output |
| Δrₙₒᵣₘ | Magnitude of position error of PVT solution |
| | normalized by the desired UERE |
| b_{RS}_{ᵢ} | RS clock bias correction of ith RS |
| b_{RS}_{ᵢ} | RS clock bias rate correction of ith RS |
| b_{SV}_{ⱼ} | SV clock bias correction of jth SV |
| b_{LOS}_{ᵢⱼ} | LOS bias between ith RS and jth SV |
| δb_{RS} | Error in RS clock bias correction |
| δb_{RS} | Error in RS clock bias rate correction |
| δb_{SV} | Error in SV clock bias correction |
| δb_{i,j} | Error in LOS bias between ith RS and jth |
| | SV |
| Δbₜᵣₒₚₒ | Tropospheric delay correction |
| b_{B&E} | B&E estimate of tropospheric delay |
| b_{A&K} | A&K estimate of tropospheric delay |
| X_{RS} | Group of RS states |
| X_{SV} | Group of SV states |
| δX_{RS} | Group of RS error states |
| χ²_{DR} | Chi squared statistic of Deltarange error |
| χ²_{PR} | Chi squared statistic of Pseudorange error |
| χ²_{PR Limit} | Chi squared limit of Pseudorange error |
| δX | Error state of all RS's and SV's being |
| | processed |
| χ²_{DR Limit} | Chi squared limit of Deltarange error |
| m_{SQM}_{ⱼ} | Quality factor of jth SV being processed |
| m_{TQM} | Overall Quality factor |
| I | Identity matrix |
| C_{No} | Signal to noise ratio of the SV as reported |
| | by the RS |

What is claimed is:

1. A system for precise relative navigation, comprising:
a plurality of reference sensors that receive data from the global positioning system;
a central processing node that receives global positioning system satellite data from each of the reference sensors, computes a set of correction parameters for each satellite based upon error detecting and minimizing algorithms housed in the central processing node, and transmits said correction parameters; and
a weapon system that receives data from the global positioning system, receives the correction parameters from the central processing node, and generates from the received data and the received correction parameters precise position information and steers itself to a target in accordance with the precise position information.

2. A method for precision navigation within a theater of operations, comprising:
receiving via GPS receivers, at each of a plurality of spaced apart known locations, GPS satellite signals from a plurality of GPS satellites, wherein the known locations approximately define the theater of operations;
providing the received GPS satellite signals to a central processing node;
filtering the provided signals to differentiate between errors local to the known locations and errors specific to the GPS satellites;
determining GPS satellite clock and ephemeris corrections based on the differentiated errors; and
transmitting the determined GPS satellite clock and ephemeris corrections to mobile units within the theater of operations.

3. The method of claim 2, wherein the determined corrections are transmitted indirectly to the mobile units.

4. The method of claim 2, wherein the received GPS satellite signals are provided asynchronously to the central processing node.

5. The method of claim 2, comprising:
prior to filtering, replacing tropospheric delay corrections added at the spaced apart known locations to the received GPS satellite signals with tropospheric delay corrections that are based on weather data for the known locations.

6. The method of claim 5, wherein the replacement tropospheric delay corrections are derived from a Black & Eisner tropospheric delay model.

7. The method of claim 2, wherein the filtering is performed utilizing an Extended Kalman Filter.

8. The method of claim 7, wherein the Extended Kalman Filter includes states for clock errors of the GPS receivers at the plurality of spaced apart known locations; and

9. The method of claim 8, wherein the Extended Kalman Filter includes line-of-sight bias residual states for each GPS satellite at each of the plurality of spaced apart known locations.

10. The method of claim 2, comprising transmitting local weather data to mobile units within the theater of operations.

11. The method of claim 10, comprising:
a first mobile unit transmitting information about its own location to the central processing unit; and
the central processing unit transmitting weather data to the first mobile unit, wherein the transmitted weather data corresponds to a location of the first mobile unit.

12. The method of claim 2, comprising:
the central processing unit receiving information from a mobile unit wherein the information indicates the mobile unit's location;
the central processing unit determining an ionospheric correction corresponding to the mobile unit's location, based on the received GPS satellite signals; and
transmitting the determined ionospheric correction to the mobile unit.

13. The method of claim 12, wherein the determined correction is transmitted indirectly to the mobile unit.

14. The method of claim 2, wherein after the central processing unit receives an new Issue of Data Ephemeris; the central processing unit continues to utilize the previous Issue of Data Ephemeris and corresponding corrections until corrections for the new Issue of Data Ephemeris are available.

15. A system for precision navigation and guidance within a theater of operations, comprising:
a plurality of spaced apart GPS sensors at calibrated locations that approximately define the theater of operations;
means for determining a measure of error in GPS satellite signals received by each GPS sensor; and
means for using the measures of error in GPS satellite signals to correct GPS satellite signals received at an unknown location within the theater of operations; and
means for using the corrected GPS satellite signals to precisely locate the unknown location within the theater of operations.

16. The system of claim 15, wherein:
each of the GPS sensors is selected from a group consisting of stationary and mobile GPS sensors.

17. The system of claim 15, wherein the GPS sensors are spaced one from another up to a maximum separation such that the GPS sensors have line of sight communications with at least four common GPS satellites.

18. The system of claim 15, further including:
means with a mobile platform within the theater of operations for receiving the measure of error in GPS satellite signals and using the measure of error to correct GPS signals received at the mobile platform; and
means at the mobile platform for using the corrected GPS signals to determine a precise location of the mobile platform.

19. The system of claim 15, further including:
means with a fire control platform within the theater of operations for receiving the measure of error in GPS satellite signals and using the measure of error to correct GPS signals received at the fire control platform; and
means at the fire control platform for using the corrected GPS signals to determine a precise location of the fire control platform.

20. The system of claim 15, further including:
means with a weapon deployed within the theater of operations for receiving the measure of error in GPS satellite signals and using the measure of error in GPS satellite signals to precisely guide the weapon to a target location within the theater of operations.

21. A method of precisely determining a location within a theater of operations that is approximately defined by a plurality of spaced apart known locations, the method comprising:
at each of the plurality of spaced apart known locations, receiving geolocation satellite signals from a plurality of geolocation satellites, wherein:
the geolocation satellite signals include time information; and
for any one of the geolocation satellites, the time information included in the geolocation satellite signals received at one of the spaced apart locations is not the same as the time information included in the geolocation satellite signals received at another of the spaced apart locations;
communicating the received geolocation satellite signals from the known locations to a processing node;
the processing node reordering the communicated geolocation satellite signals according to the time information included in the communicated geolocation satellite signals;
for each of the geolocation satellites, using the reordered geolocation satellite signals and information about the known locations to estimate an error in the received geolocation satellite signals;
for each of the geolocation satellites, communicating the estimated error to a position-determining device within the theater of operations;
the position-determining device receiving geolocation satellite signals from the geolocation satellites;
the position-determining device using the estimated errors to correct each of the received geolocation satellite signals; and
the position-determining device using the corrected geolocation satellite signals to precisely determine the location of the position-determining device within the theater of operations.

22. The method of claim 21, wherein for each of the geolocation satellites, using the reordered geolocation satellite signals and information about the known locations to estimate the error in the received geolocation satellite signals comprises using a Kalman filter to estimate the error in the received geolocation satellites.

23. The method of claim 22, wherein the Kalman filter includes a state representing an orbital position of the geolocation satellite.

24. The method of claim 22, wherein the Kalman filter includes a state representing a clock phase of the geolocation satellite.

25. The method of claim 22, wherein the Kalman filter includes states representing a clock phase at each of the spaced apart known locations.

26. The method of claim 22, wherein the Kalman filter includes states representing a clock frequency at each of the spaced apart known locations.

27. The method of claim 21, wherein communicating the received geolocation satellite signals from the known locations to the processing node includes communicating by means of Ethernet technology.

28. The method of claim 21, wherein communicating the received geolocation satellite signals from the known locations to the processing node includes communicating by means of the Internet.

29. The method of claim 21, wherein communicating the received geolocation satellite signals from the known locations to the processing node includes communicating by means of dedicated telephone connections.

30. The method of claim 21, wherein communicating the received geolocation satellite signals from the known locations to the processing node includes communicating by means of a satellite communication system.
